(19) United States
(12) Patent Application Publication
(10) Pub. No.: US 2015/0235239 A1
(43) Pub. Date: Aug. 20, 2015

(54) PREDICTING DEMAND OF A NEWLY INTRODUCED SHORT LIFECYCLE PRODUCT WITHIN AN ASSORTMENT

(71) Applicant: International Business Machines Corporation, Armonk, NY (US)

(72) Inventors: Pawan R. Chowdhary, Montrose, NY (US); Shivaram Subramanian, Danbury, CT (US); Xiaoxuan Zhang, Jersey City, NJ (US)

(73) Assignee: INTERNATIONAL BUSINESS MACHINES CORPORATION, Armonk, NY (US)

(21) Appl. No.: 14/184,316

(22) Filed: Feb. 19, 2014

(51) Int. Cl. G06Q 30/02; G06Q 50/00

(52) U.S. Cl. CPC G06Q 30/0202; G06Q 50/01

(57) ABSTRACT

Predicting demand of a newly launched product may comprise obtaining customer sentiment data associated with the newly launched product, the customer sentiment data obtained at least from social media. A mean sentiment lag associated with the customer sentiment data may be determined. A weight given to a predicted PLC effect of the newly launched product relative to customer sentiment identified in the customer sentiment data may be determined. Numerical prediction parameters from parameter values associated with a like-item that is determined to be similar to the newly launched product may be obtained. A product utility valuation may be computed as a weighted combination of the predicted PLC effect and a lagged social media sentiment determined from the customer sentiment data accounted by the mean sentiment lag. The product utility valuation provides an indication of the future demand of the newly launched product.

### FIELD

The present application relates generally to computers and computer applications, and prediction algorithms, more particularly to predicting, using a computer, future sales of products or items, and/or future sales of products or items within an assortment.

### BACKGROUND

When it comes to products that have a short lifecycle, there is insufficient data early in this process to determine how the future sales of the product will vary over time. In the past, retailers have tried to find the closest pre-existing item in their historical data as proxy for predicting in-season sales. However such methods may be error prone for two reasons. First, the customer response to a newly introduced item is unknown, and second, the newly introduced item interacts with the rest of the assortment, fundamentally altering the remainder of the lifecycle sales of all items.

Currently, the retail industry is witnessing a proliferation of merchandize that have a short lifecycle (SLC), including apparel and fashion retailers, and high-end electronics consumer product retailers, among others. New product designs are introduced in the market even as older versions or prior SLC products are cleared from the inventory or phased out. The time-span of the lifecycles themselves are getting shorter. For example a fast-fashion product lifecycle can last no more than 12-13 weeks, leaving very little time for a retailer to adapt to changing customer preferences at various locations and over time.

SLC demand forecasting would allow retailers to better allocate and manage SLC items in an assortment. However, predicting sales for newly introduced products is a challenge due to zero sales history and different store locations launching at different dates. Typically, SLC items exhibit their characteristic sales curve of an initial slow increase in sales at from the point of introduction in the market, followed by increasing sales to reach a peak value, and then a gradual decline until either all inventory is sold out or the product is removed from the market. While better forecast of new-item sales would also allow one to predict its ‘ripple effects’ on substitutes in the assortment, the current approaches may be unsuitable for this problem class due to pronounced product lifecycle (PLC) effects, low rate of sales. Since there is very limited in-season data at the start, the learning method may be relatively ineffective early in the season. PLC stands for ‘product lifecycle’.

### BRIEF SUMMARY

A method of predicting demand of a newly launched product, in one aspect, may comprise obtaining time-lagged customer sentiment data associated with the newly launched product, the customer sentiment data obtained at least from social media. The method may also comprise computing a mean sentiment time lag (or simply ‘lag’) associated with the customer sentiment data. The method may also comprise computing a weight given to a predicted product lifecycle (PLC) effect (e.g., forecasting the natural rate of sales of a product that is attributable solely to its current time-stage in its selling lifecycle) of the newly launched product relative to customer sentiment identified in the customer sentiment data. The method may also comprise identifying a like-item associated with the newly launched product. The method may also comprise obtaining numerical prediction parameters from parameter values associated with the like-item. The method may also comprise computing a product utility valuation as a weighted combination of the predicted PLC effect and a lagged social media sentiment determined from the customer sentiment data accounted by the mean sentiment lag, wherein the predicted PLC effect is determined using the numerical prediction parameters. The product utility valuation may provide an indication of the demand of the newly launched product.

A system for predicting demand of a newly launched product, in one aspect, may comprise a processor and a memory device coupled to the processor and storing customer sentiment data associated with the newly launched product, the customer sentiment data obtained at least from social media. A module may be operable to execute on the processor and compute a mean sentiment lag associated with the customer sentiment data. The module may be further operable to compute a weight given to a predicted PLC effect of the newly launched product relative to customer sentiment identified in the customer sentiment data. The module may be further operable to obtain numerical prediction parameters from parameter values associated with a like-item determined to be similar to the newly launched product. The module may be further operable to compute a product utility valuation as a weighted combination of the predicted PLC effect and a lagged social media sentiment determined from the customer sentiment data accounted by the mean sentiment lag, wherein the predicted PLC effect is determined using the numerical prediction parameters, wherein the product utility valuation provides an indication of the demand of the newly launched product.

A computer readable storage medium storing a program of instructions executable by a machine to perform one or more methods described herein also may be provided.

Further features as well as the structure and operation of various embodiments are described in detail below with reference to the accompanying drawings. In the drawings, like reference numbers indicate identical or functionally similar elements.

### BRIEF DESCRIPTION OF THE SEVERAL VIEWS OF THE DRAWINGS

FIG. 1 is a diagram showing logic flow for predicting early-lifecycle sales in the absence of sales data for a newly introduced product.

FIG. 2 is a flow diagram illustrating a sequence of calculations performed to calibrate and update demand predictions and a lifecycle utility function in one embodiment of the present disclosure.

FIG. 3 shows an SLC utility valuation model in one embodiment of the present disclosure.

FIG. 4 illustrates a schematic of an example computer or processing system that may implement a prediction system in one embodiment of the present disclosure.

### DETAILED DESCRIPTION

The ability to accurately predict the entire sales lifecycle of a SLC product by location would offer practical value to the industry. A common problem faced by retailers is that traditional time-series based smoothing or an autoregressive integrated moving average (ARIMA)-like methods cannot be used to predict lifecycle demands since there is no historical data available at the start of the selling season. Similarly, methods that are suitable for predicting cyclical demands, such as state-space models, also require significant historical data for model calibration, which is unavailable in the SLC merchandise scenario. As a result, a new class of predictive analytics that is devoted to predicting short-lifecycle sales has emerged. Such methods employ techniques like Bayesian learning, wherein the sales data associated with most similar item from past sales history is used to initialize the predictive parameters (such as price elasticity, and expected SLC profile), which are subsequently refined iteratively over time, as new sales data for the newly introduced product begins to arrive. However, the current state-of-art methods suffer from two drawbacks:

1. There is no systematic way of taking into account the impact of customer sentiment and public receptiveness to the newly introduced SLC product on the early lifecycle of the product. Consequently, the initially chosen “prior” lifecycle can significantly differ from the sales that are currently unfolding at every store location. Actions based on such projections can lead to overstocking of stores that often leads to increased price markdowns in the future, or understocking in stores, that leads to lost sales opportunities.
2. The lifecycle demand prediction does not take into account the impact of a new production introduction on the lifecycles of other substitutable SLC items in the assortment. As a result of this approximation, the sales trajectories of other items in the assortment are also over-or under-predicted, leading to a cascading demand-supply mismatch across the assortment at multiple store locations.

In the present disclosure in one embodiment, methodologies are presented for predicting sales of a newly introduced short-lifecycle product within an assortment. An embodiment of the methodology may employ a vector of social media sentiment metrics and compute its optimal time-dependent lagged correlation and elasticity with respect to the sales lifecycle, to obtain a more accurate early lifecycle profile over time. In particular, when a new product is introduced at a location, no sales data is available, whereas prior customer sentiment information about the new product may be available. Detecting and accurately measuring such a lag enables a retailer to correlate recent historical customer sentiment measures with future sales. A methodology is also presented to incorporate cross lifecycle effects within a substitutable assortment. This may be achieved by combining an assortment-normalized predicted product lifecycle effect with the aforementioned lagged customer sentiment effect within a customer choice prediction model to estimate the time-evolving market-shares of products in the assortment after new product introduction. These prediction models can be calibrated using historical data, which makes it a practically viable approach. Tests using social media blog data and a consumer product assortment indicates that significant improvements in accuracy of predicting early lifecycle sales is achievable using the methodologies of the present disclosure. Early-lifecycle refer sales refers to initial sales of an item, e.g., where no or little previous sales history is available.

Predicting Early-Lifecycle Sales in the Absence of Sales Data for a Newly Introduced Product

Since very little to no sales data is available associated with a newly introduced product, there is not a good way of really knowing if the new item sales closely resembles a chosen historical like-item (another item similar to the new item) that was used as proxy. For many consumer products, the historical customer sentiment accumulation over time, which can be obtained from an unstructured digital data source that is available for the new item, can be transformed into a structured, time-series format and used to compute a normalized, smoothed time-series of social sentiment elasticity. The like-item's Social media data may be used as an initial estimate of the new product sensitivity, as well as the characteristic time-lag between social media sentiment and sales to determine the impact of historical social sentiment on current product sales. For more expensive items, the time-lag between sentiment momentum change and sales change may be relatively longer, thereby allowing prediction of future sales for longer time horizons.

For certain other items, the sentiment lag may be less, allowing for providing predictions for a relatively shorter future time duration. In other words, a methodology of the present disclosure in one embodiment may employ the social media data effect to construct a proxy for historical sales that is either unavailable or highly limited to be of any practical use. As real sales data becomes available, the methodology of the present disclosure in one embodiment may gradually reduce the weightage given to social media sentiment, and gradually increase the weightage given to in-season historical sales time-series, in an optimal manner. The social media data and sentiment time-lag can be updated in this manner using new sales data and the forecasts can be updated.

Predicting an Impact of Newly Introduced Products on the Market-Shares of the Products within the Assortment

In addition to predicting early lifecycle sales of a new product, an embodiment of a methodology of the present disclosure may also provide lifecycle dependent cross-product impacts that occur within an assortment. An assortment is a group of substitutable products, which is typically a product category, or a specific set of items designated to be ‘substitutable’, e.g., by the seller. In this embodiment, a methodology of the present disclosure may construct a customer utility valuation over the entire lifecycle of a product. This valuation can then be within a multiple choice customer attraction based choice model (e.g., Multinomial Logit) to compute the market-share variations of any product (over its entire lifecycle) within an assortment as one or more items enter and leave the assortment. The demand for any product can be computed by multiplying the market-shares obtained in this manner, by the predicted market-size of the total assortment (i.e., the aggregate demand for the assortment), which can further be obtained using known methods (e.g., ARIMA-X tool in SPSS, or state space models). SPSS is statistics software from International Business Machines (IBM®) of Armonk, N.Y.

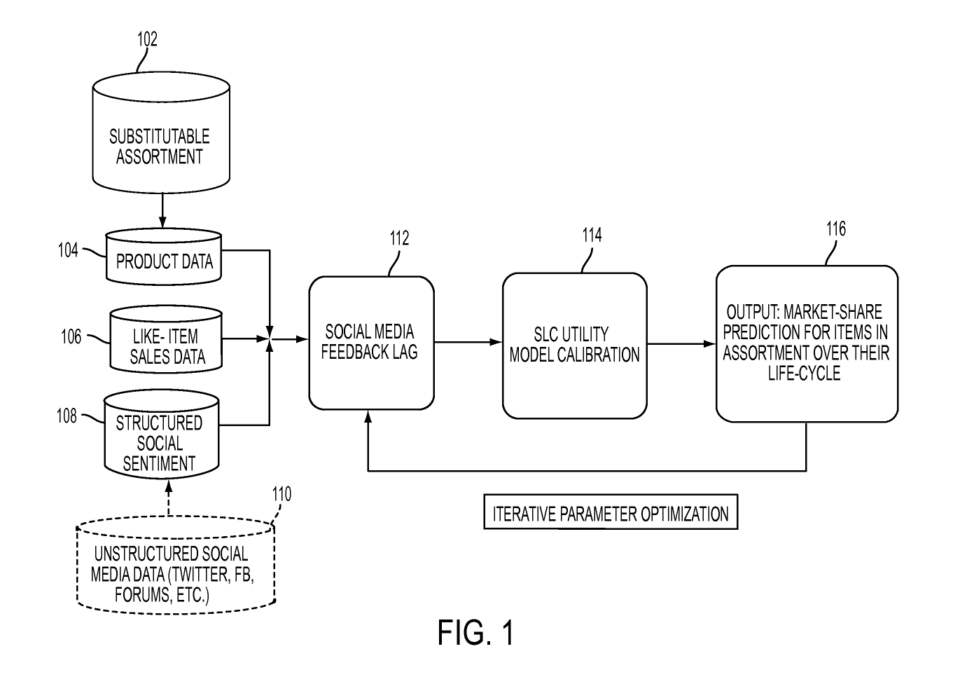

The numerical parameters required to specify the aforementioned customer utility valuation of a new product (which comprises of multiple factors such its lifecycle effect, social sentiment effect, and price effect) can be estimated via a method described above with respect to predicting early-lifecycle sales in the absence of sales data for a newly introduced product, and when an item departs from the assortment, the methodology of the present disclosure in one embodiment may exclude its utility valuation from the consideration within the customer choice set. For updating the utility valuation parameters over the lifecycle of the product, the approach similar to that shown with respect to FIG. 1 may be adopted.

These two methods allow predicting the lifecycle sales for a single product, or an assortment, which are refined over time as the assortment changes and new data becomes available.

Cross-correlation and regression analysis between the historical time-series sales data and social sentiment may be utilized, e.g., using statistical tools such as the R statistical package available for statistical computation and graphics.

In the present disclosure, the following notation are used. While the time period is referred to in terms of “week”, it should be understood that the methodology of the present disclosure may apply to different time periods, and different time period increments may be utilized.

m=number of substitutable SLC items in the current assortment.

aᵢ(t)=age (weeks) of product i at calendar week t, which is equal to the number of weeks the product has been available for sale since it was introduced at a location;

pᵢ^{t}=price of product i during calendar week t.

sᵢ^{t}=normalized social media buzz ‘lift’ for product i during week t (quantified and normalized social sentiment for product i during week t).

fₐ_{ᵢ}₍ₜ₎=represents the first component of the predicted PLC effect, and is given by the fraction of total baseline lifecycle demand for product i attributable to week aᵢ(t), which may be initialized using a like-item; baseline lifecycle demand refers to an independent demand rate of an item that is achieved without the external impact of price, customer sentiment, stock-outs, and other external factors, e.g., it represents the characteristic of (a) early lifecycle ramp-up phase, (b) intermediate peak phase, and (c) the eventual slow-down of demand as it reaches the end of its selling lifecycle. For example, suppose summer t-shirts are sold over 16 weeks from May to August. Its baseline predicted demand, while being an uncertain quantity, would start at near-zero at a=0, and is expected to steadily increase to reach its peak weekly demand rate at e.g., a=7, and then decline from that point to the end of the lifecycle (a=8 to 16) or its removal from the market, whichever occurs earlier. fₐ_{ᵢ}₍ₜ₎ varies across the life-cycle of a product and may have the classic ramp-up, peak and decline shape. fₐ_{ᵢ}₍ₜ₎ is a dimensionless quantity, e.g., value between 0 and 1, in one embodiment of the present disclosure.

Nᵢ=represents the second component of the predicted PLC effect and is given by the estimated baseline weekly sales rate (scale factor) of product i, which may be initialized using a like-item obtained, for example, as a smoothed weighted average of prior week values, or using ARIMA-like methods. The combined estimated quantity (Nᵢ fₐ_{ᵢ}₍ₜ₎ represents the predicted PLC effect, i.e., the predicted PLC sales rate of an item, aᵢ weeks after introduction. Nᵢ has a scalar quantity (e.g., units per week) in one embodiment of the present disclosure.

wᵢ=numerical parameter that represents the coefficient of convex-combination, i.e., takes a value (e.g., between [0, 1]) that represents the weight or the level of importance given by the retailer to the predicted PLC effect relative to the dynamic customer response (measured via the social media sentiment effect) for product i. In one embodiment, this value is initialized to a value close to zero (e.g., 0.1 or less) for a new product when no sales data is available and so that more reliance is placed on feedback from social media rather than unpredictable like-item based estimates to predict sales. The value may be a predefined value. This value can be then progressively adjusted as sales data for the new product is obtained, by periodically balancing the weight given to the quality of information available from social sentiment, versus the initial trends discernible from the limited amount of observed sales data.

lᵢ=mean lag (for product i) between smoothed social media buzz and sales that maximizes the log-likelihood score of model fit to like-item lifecycle data (e.g., obtained by online search from available data over duration of new product buzz). This value may be initialized using a historical like-item's mean-lag value, and updated in-season as current-item sales become available in one embodiment of the present disclosure. For example, consider the following experimental example. A particular brand of digital cameras sold by a retailer in 2012 exhibited a historical mean lag of 2.5 weeks between an increase in the rate of social media buzz and the resultant lift in observed sales. This brand-averaged value was used to initialize the mean-lag for a newly introduced digital camera model of the same brand, in the market. The updated in-season value of this lag for the new item varied between 2 and 3 weeks, and yielded the best reduction in Mean-absolute prediction error (MAPE) in predicted demand for the newly introduced camera, over the duration of the measurement (sixteen week period), i.e., yielded maximum accuracy. An experimental result showed that the prediction of a new item (a new camera) demand within an assortment of substitutable items (other cameras of the same type) improved after incorporating social sentiment effect in the prediction.

One prediction problem that may be solved is for a single SLC item. Another prediction problem that may be solved is for a group of substitutable SLC items.

Case of m=1, solving for a single SLC item.

Substitutability is ignored here, and the assortment effects are ignored. The predicted total demand for the (only) SLC item i (dᵢ^{t}) may be calculated using regression models that incorporate time-series, PLC, price, and lagged social media sentiment. For example, using logarithmic (linear) regression of observed sales versus the SLC item's own utility factors:

log dᵢ^{t}=wᵢα₀ log(Nᵢfₐ_{ᵢ}₍ₜ₎)+(1−wᵢ)αᵢ log(sᵢ^{t-l}^{ᵢ})−α₂ log(pᵢ^{t}) Eq. (1)

where the set of α are numerical parameters, N, and f, initially calibrated using a like-item and updated using in-season sales data. Hence, a method in one embodiment initializes, then continually updates the estimates of these parameters over time, e.g., using known methods such as Bayesian updating or replacing the like-item sales for the first t weeks with the actual observed sales, and re-initializing by complete re-estimation.

In the single item case, a step is provided that determines:

(i) the best-fit values for weight wᵢ and social sentiment lag lᵢ for dynamic customer sentiment impact may be computed via an “outer-loop” that performs a grid-search within pre-defined ranges. For each fixed value of (wᵢ, lᵢ), a maximum-likelihood parameter estimation (e.g., via linear regression) may be performed within an “inner loop” to determine the remaining unknown parameters. In the present disclosure, an “outer loop” represents an iterative scan of values for weight wᵢ, and social sentiment lag lᵢ over a finite set of predefined values. For any iteration, where the values for (wᵢ, lᵢ) is specified, an “inner loop” represents a parameter optimization routine that determines an appropriate choice of values for all the other unspecified parameters described in this section.

Thus, this method combines human judgment or automated intelligent determination (of like-item selection) with dynamically learning the consumer response for the new product (lagged social sentiment). The social sentiment effect is also useful throughout the lifecycle of the item, e.g., accounting for the increased magnitude of customer response to specific events such as product recall, etc.

Case of m>1, solving for a group of substitutable SLC items.

In this scenario, a method of the present disclosure in one embodiment also accounts for assortment lifecycle substitution effects. The method in one embodiment may comprise the following:

(a) predict time-series demand for an average item ( d̅ₜ) in the assortment using historical time-series data (that is readily available) to calibrate the prediction model (e.g., state space model, ARIMA-X of SPSS);
(b) multiply the prediction d̅ₜ in step (a) by m, the number of items in the current assortment, to obtain the predicted market-size for week t.
(c) The individual demands (dᵢ^{t}) are obtained by multiplying this predicted market-size by their estimated demand-share (qᵢ^{t})

dᵢ^{t}=m d̅ₜqᵢ^{t}, Eq. (2)

where
qᵢ^{t}=predicted market-share of product i in the assortment during week t (described below using attraction-based model, e.g., Multinomial Logit):

$${q}_{it} = \frac{{e}^{u ( i , t )}}{{\sum }_{j = 1}^{m} {e}^{u ( j , t )}} , \qquad Eq . ( 3 )$$

Where the assortment-normalized lifecycle utility valuation of item (u) that is active in the assortment is given by:

u(i,t)=wᵢβ₀ᵢ log(μₐ_{ᵢ}₍ₜ₎+(1−wᵢ)β₁ᵢsᵢ^{t-l}^{ᵢ}−β₂ᵢpᵢ^{t}, Eq. (4)

and the predicted assortment-normalized baseline market-share for product i in the assortment during week aᵢ(t), μₐ_{ᵢ}₍ₜ₎ is given by:

$${μ}_{{a}_{i} ( t )} = \frac{{N}_{i} {f}_{{a}_{i} ( t )}}{{\sum }_{j = 1}^{m} {N}_{j} {f}_{{a}_{j} ( t )}} \qquad Eq . ( 5 )$$

The set of β are numerical factors that represent the sensitivity of utility valuation to lifecycle, social sentiment, and price. These factors may be initialized using the parameters of a like-item and then updated using in-season sales data; and the μₐ_{ᵢ}₍ₜ₎ factors are obtained by combining the estimates for N and f, adopting a procedure described in the single-product case. e represents an exponential function.

Like-item: This is a product that is selected from the set of historical items that were sold in the same assortment (it could also represent an ‘average’ item in the assortment). Choosing such a like-item whose baseline demand profile over time is expected to best match the new item, may be done using manual selection (e.g., user or expert selection), or other known methods that automate this process by identifying a historical item that is nearest to the new item in terms of its attributes listed in the product catalog, expressed via any suitable distance function. Once the like-item is identified, its numerical parameters are employed as initial values for the new item. For example, one can expect the demand profile of a newly introduced 128 GB computer memory device to match that of the 64 GB device of the same manufacturer that was sold previously.

The above computation specifies the utility valuation (u) relative to the SLC assortment by optimally combining an assortment-normalized time effect log(p) with a measure of dynamic consumer response to individual SLC products (lagged social sentiment). This valuation represents the relative attractiveness of the item over its lifecycle compared to the rest of the assortment. In other words, the method in one embodiment may compute the market-share of any product currently in the assortment to be equal to its relative attractiveness in the current assortment. As the products in the assortment sell through their lifecycle of initial demand increase to reach a peak and then the decline to end-of-life and drop out of the assortment, the calculated market-share for each item in the assortment reflects their net relative attractiveness over time.

FIG. 1 is a diagram showing logic flow for predicting early-lifecycle sales in the absence of sales data for a newly introduced product.

Substitutable assortment 102 includes new products or items that are to be or being introduced and existing products or items that are selected as being substitutable for the one or more of the new products or items. For example, this data may include product or item identifiers, product attributes, all the numerical parameters used for prediction, and their historical sales data, if any.

Product data 104 includes information about a product whose sales data is being predicted. This may include attribute data.

Like-item sales data 106 includes information about the sales of an item that is determined to be similar to the product data 104, This data may include the selected like-item's numerical parameter values, and sales history, e.g., which may be retrieved from the substitutable assortment 102. An item is selected by a user or by finding a historical item in the assortment 102. In another aspect, a predetermined mapping that maps or co-relates items to like-items may be provided, from which a like-item may be looked up for a particular product 104, e.g., automatically by a computer-implemented method by finding a historical item whose product attributes best match the new item.

Structured social sentiment 108 includes structured data, i.e., saved in a data structure format, that describes market sentiments (e.g., sentiments or opinions of purchaser, user, etc. about a product). Such sentiments may be obtained from social media, e.g., social media database 110 (e.g., blogs, emails, messages, postings), which are usually unstructured.

Product data 104, Like-item sales data 106 and structure social sentiment data 108 are used as input data to compute (e.g. using a grid search within predefined range of values, in an outer loop) the optimal value for the mean social sentiment lag (l) 112.

SLC utility valuation calibration 114 combines an assortment-normalized time effect log(μ) with mean social sentiment lag (l) 112 to determine the relative attractiveness of the item over its lifecycle compared to the rest of the assortment, which is output as a market-share prediction for items or products in assortment 102 over their lifecycle. Equation (1) above, for instance, shows this computation.

The parameters of the social media feedback lag and SLC utility model calibration may be optimized iteratively, for example, to refine over time as the assortment (102) changes and new data becomes available.

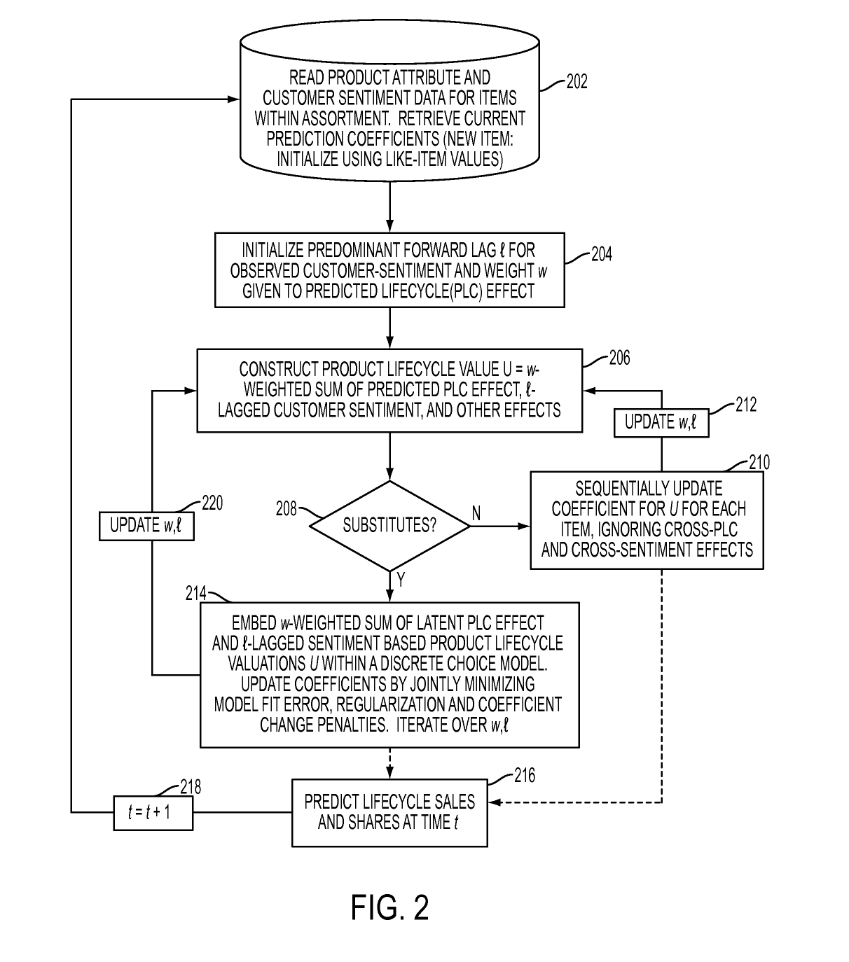

FIG. 2 is a flow diagram illustrating a sequence of calculations performed to calibrate and update demand predictions and a lifecycle utility function in one embodiment of the present disclosure. At 202, product attribute and customer sentiment data for items within assortment are obtained. For instance, the product attribute may include dimensional information (e.g., length, height, etc), functional features (e.g., capacity, operating range), brand, measure (e.g., ounces, multiple unit sets) and/or other information associated with the items. The assortment may include only the item that is new (being newly introduced) (e.g., with zero sales history). Or the assortment may include one or more products or items that are substitutable (e.g., substitutable SLC items) whose demand prediction parameters are all known and updated every period (e.g., every week).

Like-item sales data, e.g., including its sales and price history, product attributes, and relevant numerical prediction parameters is also retrieved. Like-item is an item that is determined to be similar to the item that is newly being introduced. The like-item may have been specified manually or determined by an automated computer-implemented technique. The like-item may one of the items already in the assortment (e.g., if there are items in the assortment).

The customer sentiment data may be structured data transformed from unstructured social media data about the product or like-item of the product, e.g., by employing natural language processing (NLP) techniques.

Numerical prediction parameters associated with the like-item may include the current values for these parameters, which are also retrieved. The current numerical prediction parameters may include values corresponding to the price, social sentiment, and other extraneous effects (β), and parameters related to the PLC effect such as N, f. In the below description, the terms “coefficient” and “parameter” are used interchangeably.

For a new item, these current prediction coefficients may be initialized using the like-item values or user-specified defaults for the given assortment of products.

At 204, the mean social sentiment lag l and weight w given to the predicted PLC effect is initialized. These parameters control the degree of correction effected by the current social sentiment effect on the predicted baseline demand, which for example was initialized using the values of the like-item.

At 206, a product utility valuation (u) may be constructed as a w-weighted convex combination of predicted PLC effect and mean social lag sentiment l, and other effects such as price (e.g., see Equation (1) and Equation (4)). This valuation quantifies the attractiveness of the product to a customer, combines human-judgment (or automated intelligent judgment) of selecting a like-item with forward-lagged customer sentiment to predict a new SLC product's utility valuation.

At 208, it is determined whether there is a substitute product, for example, in the assortment of substitutable products.

If there is no substitute product, at 210 coefficients for the product utility valuation (u) are sequentially updated for the new item (e.g., employing multivariate linear regression using Equation (1)), ignoring cross-PLC and cross-sentiment effect (e.g., Equation (4) need not be used in this computation) based on additional data that becomes available over time. At 212, w and l are updated based on the updated coefficients. A lifecycle demand for the product is computed at 218, using the coefficients and w and l values.

If at 208, there are substitute products, at 214, w and l are embedded based on the product utility valuation (u) (e.g., Equation (4)), within a customer choice model such as the Multinomial Logit (MNL) (e.g., Equations (2)-(5)). For any fixed pair of w and l, the coefficients of the utility functions (u) of each item in the assortment are jointly updated by minimizing model fit error, regularization and coefficient change penalties (e.g., solving a nonlinear optimization problem, e.g., using tools such as IBM ILOG CPLEX). The usage of multiple optimization objectives aim to ensure good prediction in terms of its log-likelihood or mean absolute percentage error (MAPE), smoothness of forecasts to limit excessive variations in output between successive predictions, and numerical stability.

At 216, w and l are updated in the outer loop by incrementally changing their values within a pre-defined range, and re-running the inner loop to re-optimize the parameters of u. For example, w may vary in increments of 0.1 between [0, 1], and l in an integer between [0, 6] weeks for social media data and weekly sales forecasts. This range for l is assortment-specific, and can vary depending on the type of product, and the frequency of prediction. Note that a value of l=0 indicates that the social sentiment lag and sales impact are concurrent, in which case, a methodology of the present disclosure in one embodiment may use a forecasted sentiment level (e.g., using exponential time-series smoothing) as the social media sentiment value (since the actual social sentiment value is as yet unknown).

At 218, lifecycle demand for the product and market share associated with the product at time t may be predicted. For example, the lifecycle demand of the product may be predicted using Equation (1) above. For example, the market share, and lifecycle demand associated with the product may be predicted using Equations (3) and (2) above, respectively, if for example, the assortment includes more than one item.

At 220, time period t is incremented to the next period, for prediction for that time period. The value of t is be configurable; an example includes a week, e.g., for weekly prediction. Smaller or larger increments of time may be used.

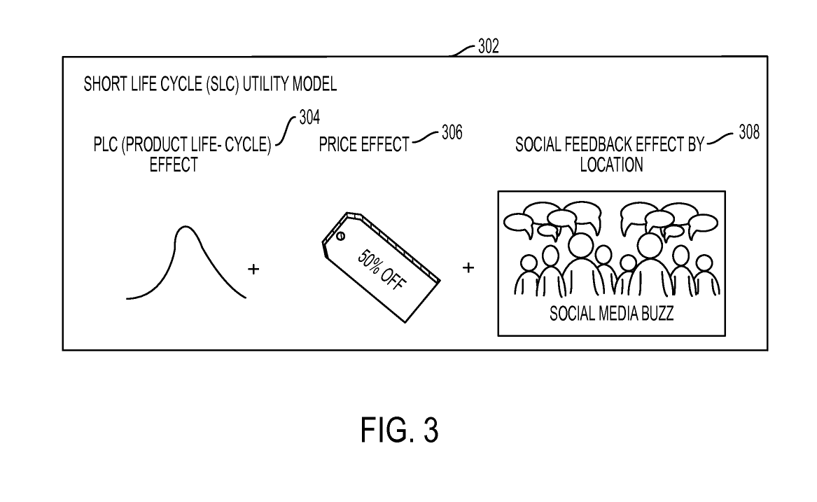

FIG. 3 shows an SLC utility model in one embodiment of the present disclosure. In one embodiment, the model uses a combination of predicted PLC effect 304, price effect 306 and social feedback effect by location 308. For instance, the structured social data may be categorized according to location, and the model may use a set of data pertaining to that location in prediction.

As described above, a methodology is presented for predicting demand of a product and also product utility valuation. The methodology may be useful in predicting lifecycle demand for short lifecycle items and assortments, e.g., fashion apparel and high tech electronics consumer products which have a naturally cyclical (boom-peak-bust) demand lifecycle and zero sales history at the time of introduction. A PLC effect refers to this cyclical demand. For example, a current assortment may include one or more substitutable short lifecycle items whose demand prediction parameters are all known and updated every week. A new item may be added to the assortment, the new item having zero sales history. To predict the new item's demand in the market, as well as the impact on the rest of the items in the assortment, the new item may be added to the “prediction model” by borrowing the prediction parameters of a like-item that is manually or automatically selected. To improve this model, the methodology of the present disclosure in one embodiment incorporates the quantified effect of lagged social media sentiment with respect to the new item: e.g., if an X % increase in positive social media buzz (an increased count of keywords in conversations that generates excitement or talk) occurred L weeks ago, it is likely that a Y % lift in sales will occur next week, where X, L, Y are initially borrowed from the like-item, and then periodically updated as new sales data become available on the new item. The prediction parameters, for example, the sentiment lags, and the numerical weights used for current items in the assortment are jointly updated weekly as new sales data becomes available. If there are no substitutes, the parameters for each item can be updated independently.

Thus, e.g., for a new item with no substitutes, lagged social media sentiment may be used to improve the prediction of early lifecycle (initial) sales of the new item (when little or no sales history is available). For example, the presence of lagged sentiment is detected and quantified, and used in the prediction of the present disclosure. For example, the time-gap or time interval between the recording of the sentiment and the impact it has on future sales provides for that lag between the sentiment and demand. For a new product, there is no sales data, but there may be a pre-existing sentiment about the product, and that pre-existing sentiment may be used in the present disclosure in one embodiment to predict future demand.

If the new item has substitutes, then the whole assortment may be impacted. Thus, the methodology of the present disclosure in one embodiment may account for cross lifecycle and cross sentiment impact between the items. Thus, e.g., the methodology of the present disclosure may jointly estimate and update the parameters. A product utility valuation (u) may be also specified that incorporates the predicted product lifecycle effect that additionally guides the prediction on how the demand of the product naturally varies over time.

In one embodiment, while the like-item data may be used to initialize prediction parameters, a methodology of the present disclosure uses the lagged social sentiment associated with the actual new product to better predict demand. This way, the demand prediction methodology of the present disclosure in one embodiment need not wait until sufficient sales data arrives (or is available) to update parameters. For example, the sentiment lag allows for improving the prediction of this week's sales by tracking social sentiment from 2-3 weeks ago (lag weeks ago).

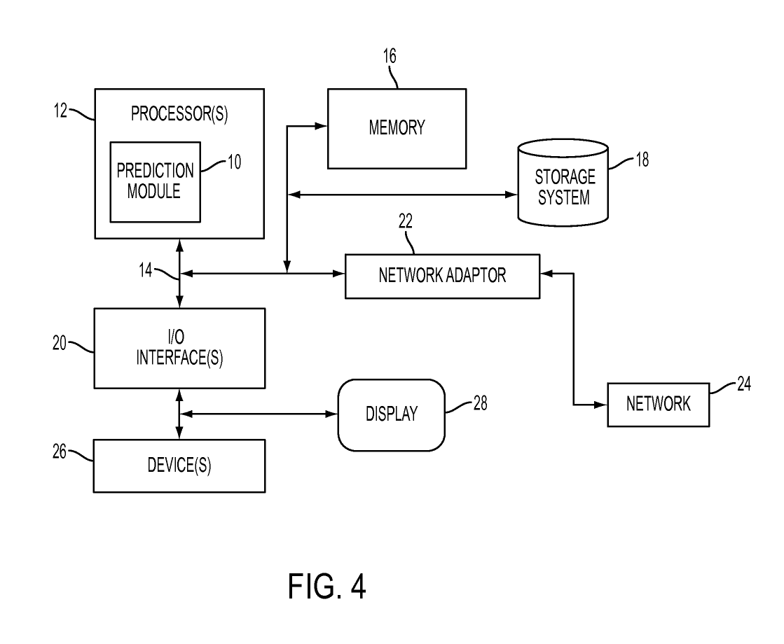

FIG. 4 illustrates a schematic of an example computer or processing system that may implement a prediction system in one embodiment of the present disclosure. The computer system is only one example of a suitable processing system and is not intended to suggest any limitation as to the scope of use or functionality of embodiments of the methodology described herein. The processing system shown may be operational with numerous other general purpose or special purpose computing system environments or configurations. Examples of well-known computing systems, environments, and/or configurations that may be suitable for use with the processing system shown in FIG. 4 may include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

The computer system may be described in the general context of computer system executable instructions, such as program modules, being executed by a computer system. Generally, program modules may include routines, programs, objects, components, logic, data structures, and so on that perform particular tasks or implement particular abstract data types. The computer system may be practiced in distributed cloud computing environments where tasks are performed by remote processing devices that are linked through a communications network. In a distributed cloud computing environment, program modules may be located in both local and remote computer system storage media including memory storage devices.

The components of computer system may include, but are not limited to, one or more processors or processing units 12, a system memory 16, and a bus 14 that couples various system components including system memory 16 to processor 12. The processor 12 may include a prediction module 10 that performs the methods described herein. The module 10 may be programmed into the integrated circuits of the processor 12, or loaded from memory 16, storage device 18, or network 24 or combinations thereof.

Bus 14 may represent one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system may include a variety of computer system readable media. Such media may be any available media that is accessible by computer system, and it may include both volatile and non-volatile media, removable and non-removable media.

System memory 16 can include computer system readable media in the form of volatile memory, such as random access memory (RAM) and/or cache memory or others. Computer system may further include other removable/non-removable, volatile/non-volatile computer system storage media. By way of example only, storage system 18 can be provided for reading from and writing to a non-removable, non-volatile magnetic media (e.g., a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 14 by one or more data media interfaces.

Computer system may also communicate with one or more external devices 26 such as a keyboard, a pointing device, a display 28, etc.; one or more devices that enable a user to interact with computer system; and/or any devices (e.g., network card, modem, etc.) that enable computer system to communicate with one or more other computing devices. Such communication can occur via Input/Output (I/O) interfaces 20.

Still yet, computer system can communicate with one or more networks 24 such as a local area network (LAN), a general wide area network (WAN), and/or a public network (e.g., the Internet) via network adapter 22. As depicted, network adapter 22 communicates with the other components of computer system via bus 14. It should be understood that although not shown, other hardware and/or software components could be used in conjunction with computer system. Examples include, but are not limited to: microcode, device drivers, redundant processing units, external disk drive arrays, RAID systems, tape drives, and data archival storage systems, etc.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages, a scripting language such as Perl, VBS or similar languages, and/or functional languages such as Lisp and ML and logic-oriented languages such as Prolog. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The computer program product may comprise all the respective features enabling the implementation of the methodology described herein, and which—when loaded in a computer system—is able to carry out the methods. Computer program, software program, program, or software, in the present context means any expression, in any language, code or notation, of a set of instructions intended to cause a system having an information processing capability to perform a particular function either directly or after either or both of the following: (a) conversion to another language, code or notation; and/or (b) reproduction in a different material form.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Various aspects of the present disclosure may be embodied as a program, software, or computer instructions embodied in a computer or machine usable or readable medium, which causes the computer or machine to perform the steps of the method when executed on the computer, processor, and/or machine. A program storage device readable by a machine, tangibly embodying a program of instructions executable by the machine to perform various functionalities and methods described in the present disclosure is also provided.

The system and method of the present disclosure may be implemented and run on a general-purpose computer or special-purpose computer system. The terms “computer system” and “computer network” as may be used in the present application may include a variety of combinations of fixed and/or portable computer hardware, software, peripherals, and storage devices. The computer system may include a plurality of individual components that are networked or otherwise linked to perform collaboratively, or may include one or more stand-alone components. The hardware and software components of the computer system of the present application may include and may be included within fixed and portable devices such as desktop, laptop, and/or server. A module may be a component of a device, software, program, or system that implements some “functionality”, which can be embodied as software, hardware, firmware, electronic circuitry, or etc.

The embodiments described above are illustrative examples and it should not be construed that the present invention is limited to these particular embodiments. Thus, various changes and modifications may be effected by one skilled in the art without departing from the spirit or scope of the invention as defined in the appended claims.

We claim:

1. A method of predicting demand of a newly launched product, comprising:
obtaining customer sentiment data associated with the newly launched product, the customer sentiment data obtained at least from social media;
computing, by a processor, a mean sentiment lag associated with the customer sentiment data;
computing, by the processor, a weight given to a predicted product lifecycle (PLC) effect of the newly launched product relative to customer sentiment identified in the customer sentiment data;
identifying a like-item associated with the newly launched product;
obtaining numerical prediction parameters from parameter values associated with the like-item; and
computing, by the processor, a product utility valuation as a weighted combination of the predicted PLC effect and a lagged social media sentiment determined from the customer sentiment data accounted by the mean sentiment lag, wherein the predicted PLC effect valuation is determined using the numerical prediction parameters;
wherein the product utility valuation provides an indication of the future demand of the newly launched product.

2. The method of claim 1, further comprising updating the mean sentiment lag and the weight given to the predicted PLC effect with additional social media data and sales data that become available.

3. The method of claim 2, further comprising updating the numerical prediction parameters using the updated mean sentiment lag and the weight.

4. The method of claim 3, further comprising recomputing the product utility valuation based on the updated mean sentiment lag, the weight given to the predicted PLC effect, and the updated numerical prediction parameters.

5. The method of claim 1, wherein the numerical prediction parameters comprise at least parameters related to price, social media sentiment and PLC effect.

6. The method of claim 5, wherein the mean sentiment lag is initialized with the like-item's mean sentiment lag value.

7. The method of claim 1, wherein for one or more of substitutable products that are identified, jointly updating coefficients of a product utility function of each of the substitutable products to account for cross lifecycle and cross sentiment impact among the newly launched product and the one or more of substitutable products.

8. The method of claim 1, wherein the customer sentiment data comprises social media indicators comprising smoothed and normalized measurements of changes in sentiment, comprising one or more of buzz, positive sentiment, negative sentiment, intent to purchase, and prior ownership.

9. A computer readable storage medium storing a program of instructions executable by a machine to perform a method of predicting demand of a newly launched product, the method comprising:
obtaining customer sentiment data associated with the newly launched product, the customer sentiment data obtained at least from social media;
computing, by a processor, a mean sentiment lag associated with the customer sentiment data;
computing, by the processor, a weight given to a predicted product lifecycle (PLC) effect of the newly launched product relative to customer sentiment identified in the customer sentiment data;
identifying a like-item associated with the newly launched product;
obtaining numerical prediction parameters from parameter values associated with the like-item; and
computing, by the processor, a product utility valuation as a weighted combination of the predicted PLC effect and a lagged social media sentiment determined from the customer sentiment data accounted by the mean sentiment lag, wherein the predicted PLC effect is determined using the numerical prediction parameters;
wherein the product utility valuation provides an indication of the demand of the newly launched product.

10. The computer readable storage medium of claim 9, further comprising updating the mean sentiment lag and the weight given to the predicted PLC effect with additional social media data and sales data that become available.

11. The computer readable storage medium of claim 10, further comprising updating the numerical prediction parameters using the updated mean sentiment lag and the weight.

12. The computer readable storage medium of claim 11, further comprising recomputing the product utility valuation based on the updated mean sentiment lag, the weight given to the predicted PLC effect, and the updated numerical prediction parameters.

13. The computer readable storage medium of claim 9, wherein the numerical prediction parameters comprise at least parameters related to price, social media sentiment and lifecycle demand profile.

14. The computer readable storage medium of claim 13, wherein the mean sentiment lag is initialized with the like-item's mean sentiment lag value.

15. The computer readable storage medium of claim 9, wherein for one or more of substitutable products that are identified, jointly updating coefficients of a product utility function of each of the substitutable products to account for cross lifecycle and cross sentiment impact among the newly launched product and the one or more of substitutable products.

16. The computer readable storage medium of claim 9, wherein the customer sentiment data comprises social media indicators comprising smoothed and normalized measurements of changes in sentiment, comprising one or more of buzz, positive sentiment, negative sentiment, intent to purchase, and prior ownership.

17. A system for predicting demand of a newly launched product, comprising:
a processor;
a memory device coupled to the processor and storing customer sentiment data associated with the newly launched product, the customer sentiment data obtained at least from social media;
a module operable to execute on the processor and compute a mean sentiment lag associated with the customer sentiment data,
the module further operable to compute a weight given to a predicted product lifecycle (PLC) effect of the newly launched product relative to customer sentiment identified in the customer sentiment data,
the module further operable to obtain numerical prediction parameters from parameter values associated with a like-item determined to be similar to the newly launched product, and the module further operable to compute a product utility valuation as a weighted combination of the predicted PLC effect and a lagged social media sentiment determined from the customer sentiment data accounted by the mean sentiment lag, wherein the predicted PLC effect is determined using the numerical prediction parameters,
wherein the product utility valuation provides an indication of the demand of the newly launched product.

18. The system of claim 17, wherein the module is further operable to update the mean sentiment lag and the weight given to the predicted PLC effect with additional social media data and sales data that become available.

19. The system of claim 18, wherein the module is further operable to update the numerical prediction parameters using the updated mean sentiment lag and the weight.

20. The system of claim 18, wherein the module is further operable to recompute the product utility valuation based on the updated mean sentiment lag, the weight given to the predicted PLC effect, and the updated numerical prediction parameters.
